(19) United States
(12) Patent Application Publication
(10) Pub. No.: US 2009/0297753 A1
(43) Pub. Date: Dec. 3, 2009

(54) BULLETIN BOARD

(76) Inventor: Kara Romanik, San Rafael, CA (US)

Correspondence Address: DERGOSITS & NOAH LLP, Suite 1450, Four Embarcadero Center, San Francisco, CA, 94111, US

(21) Appl. No.: 12/132,086

(22) Filed: Jun. 3, 2008

(51) Int. Cl. B32B 33/00

(52) U.S. Cl. 428/42.1

(57) ABSTRACT

A bulletin board is made by assembling a board with a compressible material that is covered with a t-shirt material having ornamental markings for a school. Ribbons are placed across the t-shirt material and held in place with fasteners and a sculptural piece associated with the school is placed over the ribbons to secure the ribbons to the board.

### BACKGROUND

A bulletin board is a place where a user can leave information or messages. Bulletin boards are often made of a material such as cork to facilitate addition and removal of messages. The messages can also be held in place with ribbons. Although plain bulletin boards have been available for many years, they typically lack personalization or association with any organization such as a school or sports team.

### SUMMARY OF THE INVENTION

The present invention is directed towards a memo board that utilizes a t-shirt material having a design and a logo. In an embodiment, the memo board is made from a rigid board and some compressible material such as batting. The board is covered with a cotton t-shirt material that holds the compressible material against the board. The t-shirt can be secured in place with fasteners such as staples, nails, tacks, etc.

The t-shirt material is a specific type of knitted fabric that has many alternating knit and purl stitches that form a “jersey stitch.” The weave is fairly wide so the board can also be used as a tack board so the sharp point can be inserted through the woven fabric. In addition to the special material, the t-shirt material can have text printed on the material. The text may be directed towards a team or a school, college or university name.

Ribbon materials are wrapped around the board in a pattern with crossed sections of ribbon. Tacks can be used to secure the ribbons to the board at the crossed sections. Schools and sports teams typically have two team colors. The shirt material may be the primary color and the ribbon may be the same or a similar color. A sculpture can be placed at a center portion of the bulletin board at a ribbon crossing point. The sculpture may be the mascot of the school or sports team.

### BRIEF DESCRIPTION OF THE DRAWINGS

FIG. 1 illustrates a t-shirt which can be used as a component of the inventive bulletin board;

FIG. 2 illustrates a cross section side view of the bulletin board being assembled;

FIG. 3 illustrates a cross section side view of the bulletin board partially assembled; and

FIG. 4 illustrates a front view of the bulleting board after assembly.

### DETAILED DESCRIPTION

The present invention is directed towards a bulletin board having a rigid surface covered with a batting or other compressible material and a sheet of fabric having an ornamental design. Ornamental ribbons extend across the board and compress the batting. The ribbons may also be attached to the bulletin board with fasteners that also compress the batting at various points across the rigid surface. The ribbons and batting provide a mechanism for securing flat items such as paper to the bulletin board. The user can place pieces of paper under the ribbons which securely hold the paper in place against the compressed batting.

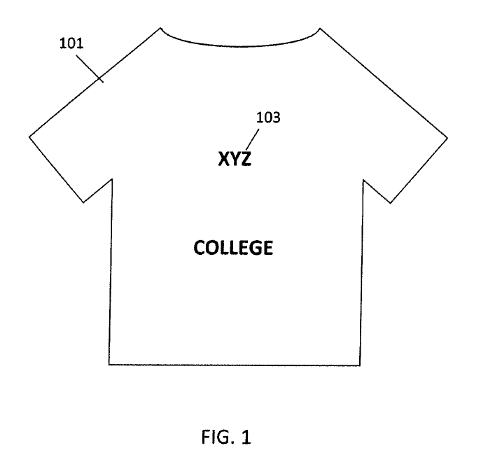

With reference to FIG. 1, in the preferred embodiment, the woven fabric is a t-shirt 101 material that includes text 103 for a school. In other embodiments, the t-shirt 101 can include a logo, a mascot illustration, an emblem or any other illustration that is associated with a school, college or university. In other embodiments, the text, graphics or illustration can be associated with a sports team.

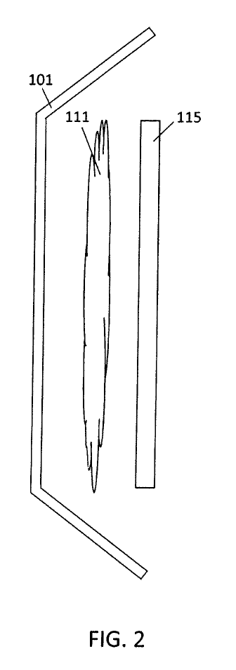

With reference to FIG. 2, a side view of the bulletin board assembly is illustrated. The board 115 can be a rigid board such as particle board, wood, plastic, metal or cork. A compressible material 111 such as a batting material made of cotton, polyester and/or wool. In other embodiments, the compressible material 111 can be a foam or pillow type material that is elastic and compressible.

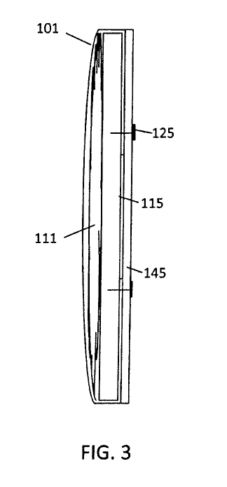

With reference to FIG. 3, the t-shirt 101 material can be wrapped around the back of the board 115. A back board 145 may also be attached to the back of the board 115. Tacks 125 can be used to hold the back board 145 and t-shirt 101 material against the board 115. The t-shirt 101 also functions to hold the compressible material 111 in place. The compressed material 111 presses outward against the t-shirt 101 material.

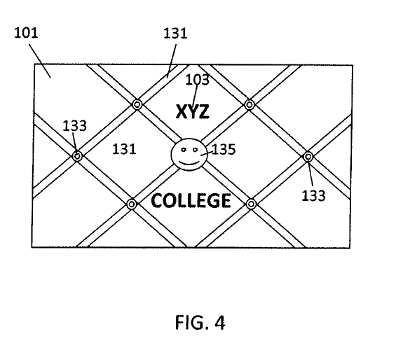

With reference to FIG. 4, a front view of the bulletin board is illustrated. The printing 103 marked on the front of the t-shirt 101 can be centered on the board and ribbons 131 are placed across the t-shirt 101 at opposite angles so that the ribbons 131 intersect at various points. Ornamental fasteners 133 can be placed over the points where the ribbons 131 intersect to hold the ribbons 131 against the bulletin board and an ornamental sculptural piece 135 can be attached to a center intersection point. The sculptural piece 135 can be associated with the organization printed 103 on the t-shirt 101. For example, the printing 103 can be a school and the sculptural piece 135 can be the school mascot. In other embodiments, the printing 103 can be a sports team and the sculptural piece 135 can be a team mascot.

In order for the bulletin board to have an attractive appearance, the fabric must also conform to the non-planar batting material. In the preferred embodiment, the fabric is a knitted fabric created by a knitting machine. Knitted fabric consists of parallel courses of yarn. The courses are joined to each other by interlocking loops in which a short loop of one course of yarn is wrapped over the bight of another course. The knitting is begun by forming a base series of twisted loops of yarn. A needle is then used to reach through each loop or stitch in succession in order to snag a bight of yarn and pull a length back through the loop. This forms a new stitch at the top of the current wale of stitches or loops. The cloth is formed by going back and forth in rows of stitches.

The two basic stitches are knit and purl. These two nominal stitches are the obverse and reverse of the same stitch. A knit stitch is formed by inserting the needle in the front of the loop and pulling a loop of yarn through to form a new loop, while a purl stitch is formed by inserting the needle in the back of the loop and pushing a loop of yarn through to form a new loop. Only knits or only purls are used when working back and forth in rows, the alternating rows of knits and purls is known as a “jersey stitch” which gives the t-shirts a distinctive soft texture. The alternating rows of the jersey stitch create many small grooves that extend is a straight line across the fabric. The grooves of the t-shirt are typically oriented in a vertical manner along the length of the t-shirt. In a preferred embodiment, the vertical grooves are vertically aligned with the height of the bulletin board.

The use of a t-shirt material with the inventive bulletin board is of particular importance because it provides a distinctive appearance to the bulletin board. Users and viewers can immediately recognize the material as being a t-shirt and associate the bulletin board with the organization, school or team. If the bulletin board is marked with school text, the user will feel supportive or nostalgic of the school when using the bulletin board.

The use of t-shirt material on a bulletin board is particularly useful because it provides a flexible and elastic material that conforms to the undulating surface of the bulletin board and compressible material. The surface is also soft to the touch and textured so that the pieces of paper are securely held in place by the tension of the ribbons against the compressed material. The t-shirt material is also easily cleaned. If necessary, the entire bulletin board can be washed and dried.

In a preferred embodiment the board can be a piece of particle board which has the dimensions 14 inches by 18 inches and ⅜ inch thick. In other embodiments, the board can be plastic, wood or any other rigid material such as cork, composite such as fiberglass or metal. The batting can be a mass or layers or sheets of raw cotton or wool or of synthetic fibrous material used. The batting material can be cut into a sheet that may be about 16 inches by 18 inches so that is can be wrapped around the two side edges of the board. The t-shirt is then placed over the batting and around the board. The t-shirt may compress the batting and be attached to the board with staples using a staple gun. The staples may be ⅜ inch or 10 mm staples. In other embodiments, any other type of fastener can be used including: screws, nails, bolts, hooks, adhesives, straps, tape, Velcro, etc.

The ribbons can then placed over the board in a criss-cross pattern and the ends of the ribbon can be secured to the back of the board with staples using the stable gun. At the points where the ribbons intersect on the front of the board, wire nails can be used to attach the ribbons to the board. The ribbons are illustrated in a diamond pattern in FIG. 4, however in other embodiments, the ribbons can be arranged in a square, rectangular or any other geometric pattern.

A melamine back board that is ¼ inch thick and about 13 inches by 17 inches can be attached to the back of the board with glue and nails or any other fastener. In other embodiments, the back board can be wood, metal, plastic, etc. The glue can be thermoplastic adhesive which is melted in a hot glue gun which contains a heating element. The thermoplastic adhesive is tacky when hot, but hardens and stops being sticky quickly. In other embodiments, any other suitable glue can be used.

Wall hooks can also be attached to the sides of the back of the board so the board can be hung on a wall. The sculptural piece is attached to the front of the board. The sculptural piece can be any sized but should be less than a few inches wide so the board can be used. Brads or snaps are attached to the points on the front of the board where the ribbons intersect. The brads or snaps may be about 8 mm in diameter.

It will be understood that the inventive system has been described with reference to particular embodiments, however additions, deletions and changes could be made to these embodiments without departing from the scope of the inventive system. Although the bulletin boards that have been described include various components, it is well understood that these components and the described configuration can be modified and rearranged in various other configurations.

1. A bulletin board comprising:
a board having a planar surface;
a fabric made from a cotton thread woven in a jersey weave, wherein the fabric surrounds the planar surface of the board;
an ornamental marking printed on an outer surface of the fabric;
a layer of compressible material positioned between the sheet of fabric and the board;
a plurality of ribbons that are coupled to the outer side of the sheet of fabric; and
an ornamental sculpture coupled to the outer side of the sheet of fabric.

2. The bulletin board of claim 1 wherein the fabric is at least a portion of a t-shirt.

3. The bulletin board of claim 1 wherein the ornamental marking is a name of a sports team and the ornamental sculpture is a mascot of the sports team.

4. The bulletin board of claim 1 wherein the ornamental marking is a name of a school and the ornamental sculpture is a mascot of the school.

5. The bulletin board of claim 1 wherein the ornamental marking is a logo of a school and the ornamental sculpture is a mascot of the school.

6. The bulletin board of claim 1 further comprising:
ribbons that extend across the planar surface of the board.

7. The bulletin board of claim 6 further comprising:
fasteners that are coupled to the ribbons to secure the ribbons to the board.

8. The bulletin board of claim 7 wherein the ribbons cross each other and the fasteners are coupled to the ribbons at points where the ribbons cross each other.

9. A method for making a bulletin board comprising:
providing a fabric made from a thread woven in a jersey weave having an ornamental marking on an outer side;
providing a board having a planar surface;
placing a layer of compressible material over the planar surface;
placing the fabric over the layer of compressible material and the planar surface of the board;
attaching the fabric to the board with a plurality of fasteners;
attaching plurality of ribbons across the outer side of the fabric; and
attaching an ornamental sculpture to the board.

10. The method of claim 9 wherein the thread is at least partially made of cotton.

11. The method of claim 9 further comprising:
securing ribbons to the board with ornamental fasteners.

12. The method of claim 11 further comprising:
compressing portions of the compressible material with the ornamental fasteners.

13. The method of claim 9 further comprising:
aligning the jersey weave with a vertical orientation of the board.

14. The method of claim 9 further comprising:
wherein the ornamental marking is associated with an organization and the ornamental sculpture is associated with the organization.

15. A bulletin board kit comprising:
a t-shirt made from a thread woven in a jersey weave having an ornamental marking on an outer side;
a rectangular board having a planar surface;
a batting material placed over the planar surface of the board;
fasteners for attaching the t-shirt to the board to secure the batting material to the board; and
plurality of ribbons that are attached across the outer side of the t-shirt;
an ornamental sculpture coupled to the board.

16. The bulletin board kit of claim 15 wherein the thread is made of 100% cotton.

17. The bulletin board kit of claim 15 further comprising:
ornamental fasteners for securing the plurality of ribbons to the board.

18. The method of claim 17 wherein the t-shirt is a first color and the ribbon is also the first color.

19. The method of claim 15 further comprising:
a back board that is attached to the rectangular board.

20. The method of claim 15 wherein the ornamental marking is associated with a school and the ornamental sculpture is mascot for the school.

21. A bulletin board comprising:
a board having a planar surface;
a fabric made from a cotton thread woven in a jersey weave, wherein the fabric surrounds the planar surface of the board;
a layer of compressible material positioned between the sheet of fabric and the board; and
a plurality of ribbons that are coupled to the outer side of the sheet of fabric.

22. The bulletin board of claim 21 wherein the fabric is at least a portion of a t-shirt.

23. The bulletin board of claim 21 further comprising:
an ornamental marking printed on an outer surface of the fabric; and
an ornamental sculpture is that is coupled to the bulletin board.

24. The bulletin board of claim 23 wherein the ornamental marking is a name of a school and the ornamental sculpture is a mascot of the school.

25. The bulletin board of claim 23 wherein the ornamental marking is a logo of a school and the ornamental sculpture is a mascot of the school.
